(19) United States
(12) Patent Application Publication
(10) Pub. No.: US 2018/0268056 A1
(43) Pub. Date: Sep. 20, 2018

(54) Computing Device and/or Intelligent Shading System with Color Sensor

(71) Applicant: Shadecraft, LLC, Glendale, CA (US)

(72) Inventor: Armen Sevada Gharabegian, Glendale, CA (US)

(73) Assignee: Shadecraft, LLC

(21) Appl. No.: 15/460,203

(22) Filed: Mar. 15, 2017

(51) Int. Cl. G06F 17/30; G01J 3/50; G06F 3/16; G11B 27/11; G11B 27/34

(52) U.S. Cl. CPC G06F 17/30802; G01J 3/50; G06F 17/30743; G11B 27/11; G11B 27/34; G06F 3/165

(57) ABSTRACT

A computing device including a color spectrum detector, a memory, a processor, a database and computer-readable instructions, stored in the memory, fetched from the memory and executed by the processor. The color spectrum detector to detect a change in a color spectrum over a specified period of time and to generate a signal representative of color spectrum change and the database housing digital media files. The computer-readable instructions executed by the processor to receive the signal representative of the color change, generate a value indicator based at least in part on the received color spectrum change, selected one or more digital media files from the database having a selection indicator corresponding to the value indicator representative of the color spectrum change and retrieve the one or more selected digital media files.

### RELATED APPLICATIONS

### BACKGROUND

### 1. Field

The subject matter disclosed herein relates to a computing device selecting digital media files in response to detection of a color and/or light change.

### 2. Information/Background of the Invention

Computing devices housing digital media players (e.g., an MP3 player, an iPhone or other mobile communications and/or computing device having an iTunes, Pandora or Spotify software application installed thereon) played a set list of tunes selected and/or created by a user and/or a third party. A playlist or a song may only be changed or modified by operator/user intervention. Environments in which a computing device and/or umbrella may be located may experience a change in weather conditions and this may impact what music is selected and being audibly reproduced or played. Accordingly, there is a need for a computing device to play music to match environmental conditions according to embodiments of the invention.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 illustrates a computing device comprising a color sensor and/or detector according to embodiments;

FIG. 2 illustrates a flowchart of a process comprising automatic selecting of digital media files via color detection according to embodiments;

FIG. 3 illustrates a modular umbrella shading system including a color sensor or detector according to embodiments;

FIG. 4 illustrates an intelligent shading system comprising one or more laser devices and/or one or more two dimensional scanners according to embodiments; and

FIG. 5 illustrates a method and/or process for capturing measurements from a plurality of sensors and selecting digital media files in response.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

A network may comprise two or more network and/or computing devices and/or may couple network and/or computing devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments.

Computing devices, mobile computing devices, and/or network devices capable of operating as a server, or otherwise, may include, as examples, rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases, database servers, application data servers, proxy servers, and/or portions thereof, as appropriate.

It should be understood that for ease of description a network device may be embodied and/or described in terms of a computing device and/or mobile computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include for example, past, present and/or future mass storage, such as network attached storage (NAS), cloud storage, a storage area network (SAN), cloud storage, cloud server farms, and/or other forms of computing and/or device readable media, for example. A network may include a portion of the Internet, one or more local area networks (LANs), one or more wide area networks (WANs), wire-line type connections, one or more personal area networks (PANs), wireless type connections, one or more mesh networks, one or more cellular communication networks, other connections, or any combination thereof. Thus, a network may be worldwide in scope and/or extent.

The Internet and/or a global communications network may refer to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet may include local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices and/or computing devices may engage in an HTTP session through an exchange of appropriately compatible and/or compliant signal packets and/or frames. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. A content delivery server and/or the Internet and/or the Web, therefore, in this context, may comprise an service that organizes stored content, such as, for example, text, images, video, etc., through the use of hypermedia, for example. A HyperText Markup Language (“HTML”), Cascading Style Sheets (“CSS”) or Extensible Markup Language (“XML”), for example, may be utilized to specify content and/or to specify a format for hypermedia type content, such as in the form of a file and/or an “electronic document,” such as a Web page, for example. HTML and/or XML are merely example languages provided as illustrations and intended to refer to any version, now known and/or developed at another time and claimed subject matter is not intended to be limited to examples provided as illustrations, of course.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as 1) time of day at which an image was captured, latitude and longitude of an image capture device, such as a camera; 2) time and day of when a sensor reading (e.g., humidity, temperature, air quality, UV radiation) was received; and/or 3) operating conditions of one or more motors or other components or assemblies in a modular umbrella shading system. Claimed subject matter is intended to embrace meaningful, descriptive parameters in any format, so long as the one or more parameters comprise physical signals and/or states, which may include, as parameter examples, name of the collection of signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a shading object computing device). In the context of this specification, therefore, a special purpose computer or a similar special purpose electronic computing device (e.g., a modular umbrella computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., an intelligent, automated shading object or umbrella, modular umbrella, and/or shading charging systems, and various other electronic and mechanical devices coupled thereto or installed thereon. Microcontrollers may include processors, microprocessors, and other electronic components. Controller may be a commercially available processor such as an Intel Pentium, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. Usually, a processor or controller, may execute an operating system which may be, for example, a Windows-based operating system (Microsoft), a MAC OS System X operating system (Apple Computer), one of many Linux-based operating system distributions (e.g., an open source operating system) a Solaris operating system (Sun), a portable electronic device operating system (e.g., mobile phone operating systems), microcomputer operating systems, and/or a UNIX operating systems. Embodiments are not limited to any particular implementation and/or operating system.

In embodiments, a computing device may comprise one or more controllers/processors, one or more memories, one or more transceivers, and one or more sensors. In embodiments, a sensor or detector may detect changes in conditions or an environment surrounding and/or adjacent to a computing device. In embodiments, a sensor may detect color spectrums, color light or a color light part of a spectrum. In embodiments, a sensor may be a color detector or a color sensor. In embodiments, for example, a color detector sensor may comprise a 3-channel (RGB) photodiode. In embodiments, a 3-channel (RGB) sensor may be sensitive to blue, green and/or red regions of a color spectrum. In embodiments, a color sensor may transmit light against an object and red, green and blue filters may measure reflected color light and/or intensity of the reflected color light. In embodiments, a color sensor may measure existing light in a room, inside environment and/or outside environment through red, green and blue filters to determine measurements of red, green and/or blue portions of a light spectrum (and may not need to have light reflected off a surface and/or object). In embodiments, a color sensor may be a CMYK color sensor, where a sensor recognizes and/or measures cyan, magenta, yellow and/or black light and/or intensity (in some cases reflected off of a surface). In embodiments, a CMYK color sensor may be sensitive to cyan, magenta, yellow and/or black regions of a color spectrum. In embodiments a color sensor may be a Hamamatsu™ RGB sensor and an illuminance sensor. In embodiments, a color sensor may be a Nix or Nix Pro CYMK color sensor. In embodiments, a color sensor and/or a color detector may be part of a module and/or may be mounted on a printed circuit board. In embodiments, a color module may also include other components and traces, including but not limited to one or more processors, one or more controller and/or one or more memory modules. In embodiments, a color module may perform some initial processing on received color sensor measurements. In embodiments, for example, a color module may determine if a change in color has exceeded a threshold and may generate a command, signal, message and/or measurement with a value representative of a change in color. In embodiments, a color module may receive color sensor measurements and calculate a color gradient (e.g., a change in color) measurement. In embodiments, computer-readable instructions stored in one or more memories may calculate color change measurements and/or color gradient measurements after receiving color sensor measurements. In embodiments, a color sensor and/or color detector may also be utilized for proximity detection.

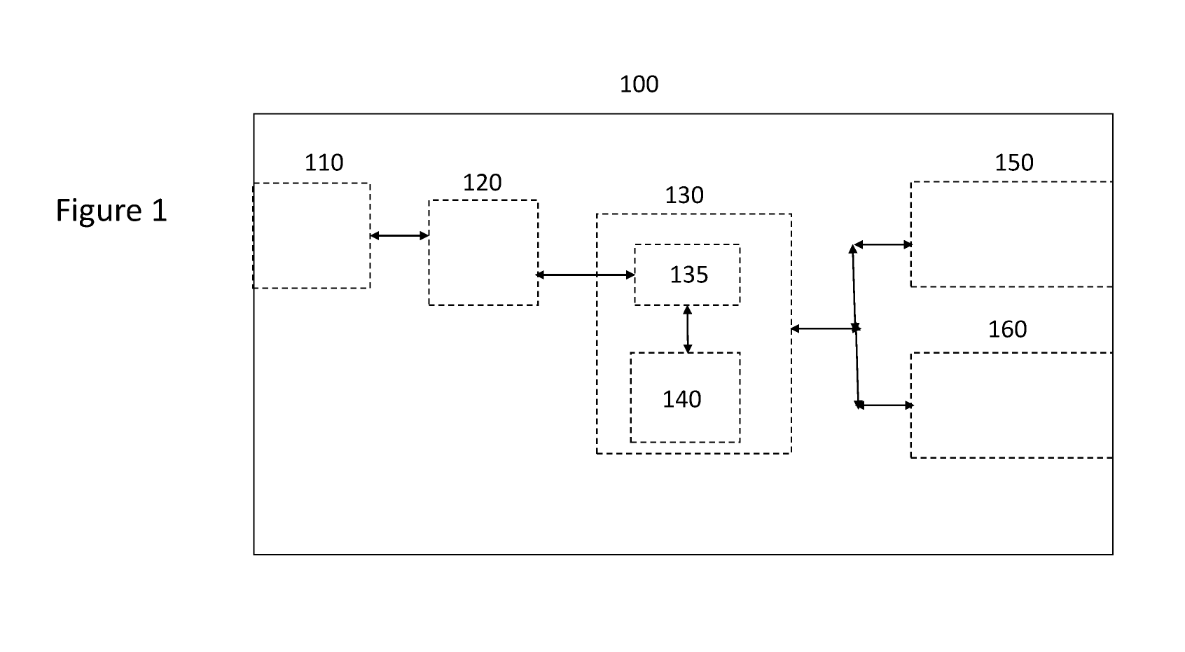

FIG. 1 illustrates a computing device comprising a color sensor and/or detector according to embodiments. In embodiments, a computing device 100 may comprise one or more color sensors and/or detectors 110, one or more controllers and/or processors 120, one or more memory modules 130, one or more database systems or modules 140, one or more sound reproduction systems 150, and/or one or more displays and/or monitors 160. In embodiments, a computing device may also comprise one or more transceivers and/or input/output devices for communicating with other computing devices. In embodiments, one or more color sensors or detectors 110 may communicate signals, messages, instructions and/or measurements to one or more controller and/or processors 120. In embodiments, for example, these measurements may be color sensor or detector measurements, color sensor or detector change measurement, and/or color sensor or detector color gradient measurements. In embodiments, computer-readable instructions stored in one or more memory modules 130 may be executed by one or more processors 120 to perform a color analyzation method or process to calculate and/or generate color values or color value indicators representative and/or associated with captured color measurements. In embodiments, color indicators and/or values may also be referred to as indicator values and/or color indicator values. In embodiments, computer-readable instructions executable by one or more processors and/or controllers 120 may retrieve media files from a data base module 140 having matching color selection indicators or color selection values to the received color value indicators and/or color values. In embodiments, one or more processors and/or controllers 120 may communicate and/or transfer retrieved media files from the database module 140 to a sound reproduction system 150 for audible playback and/or may communicate and/or transfer retrieved media files to a display and/or monitor 160 for visual display and/or audible playback. In embodiments, media files may be analog and/or digital media files. In embodiments, media files may be music media files or music files and/or video media files or video files, a combination of both.

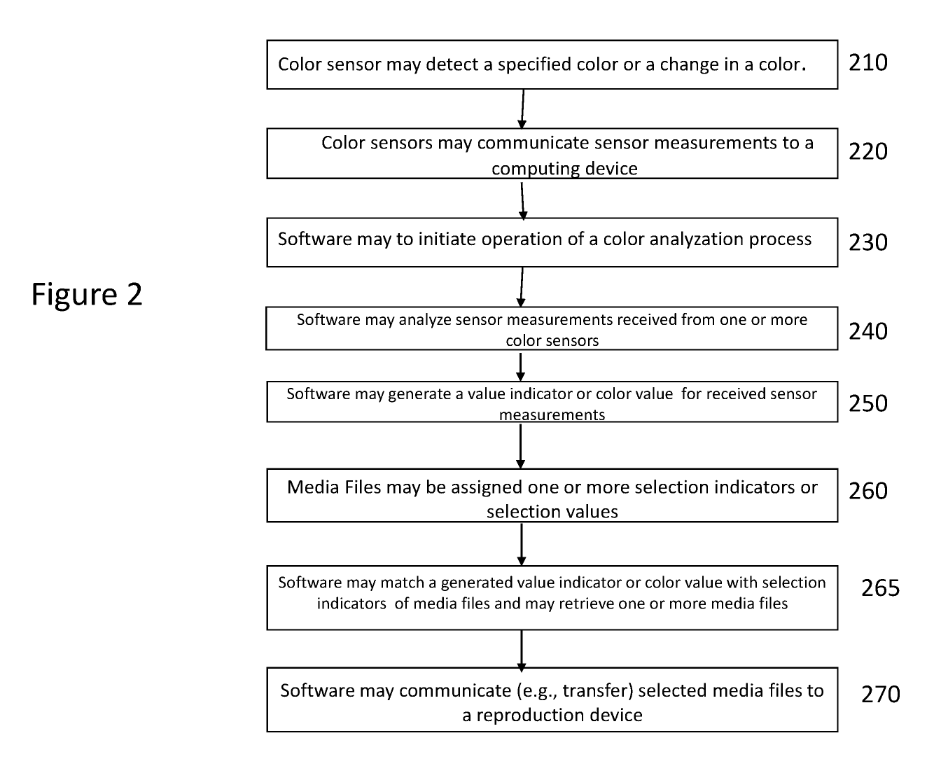

FIG. 2 illustrates a flowchart of a process comprising automatic selecting of digital media files via color detection according to embodiments. In embodiments, a color sensor and/or detector may detect or sense 210 a specified color and/or may detect or sense a change in a specified or identified color. In embodiments, detected colors may be red, green or blue. In embodiments, detected colors may be cyan, yellow, magenta, and/or black. In embodiments color sensors and/or color detectors may communicate 220 sensor measurements and/or processed sensor measurements to a computing device. In embodiments, sensor measurements may comprise indicators and/or values representative of red spectrum light, blue spectrum light, and/or green spectrum light. In embodiments, sensor measurements may comprise indicators and/or values representative of changes for a specified time for red color spectrum light, green color spectrum light and/or blue color spectrum light. Similarly, sensor measurements may comprise cyan color (or cyan color light), yellow color (or yellow color light), magenta color (or magenta color light) and/or black color (or black color light) spectrum light. In embodiments, a computing device may also comprise one or more processors and one or more memory modules. In embodiments, a computing device may be located and/or positioned in a same structure as a color sensor and/or detector (e.g., an intelligent shading system, an intelligent umbrella, an AI device like Amazon Alexa or echo, or Google Now may comprise one or more processors, one or more memory modules and/or one or more color sensors).

In embodiments, computer-readable instructions may be stored on one or more memory modules, may be fetched from the one or more memory modules and executed 230 by the one or more processors to initiate operation of a color analyzation process. In embodiments, computer-readable instructions executed by a processor or a controller may analyze 240 one or more sensor measurements received from one or more color sensors and/or detectors. In embodiments, computer-readable instructions may analyze whether received sensor and/or detector measurements exceed a specified threshold. In embodiments, for example, computer-readable instructions executed by a processor and/or controller may analyze received red, green and/or blue light measurements in a spectrum to determine if the received sensor measurements exceed thresholds set for red, green and/or blue light measurements. In embodiments, computer-readable instructions executed by a processor or controller may analyze received color changes (or color measurement changes) and/or color gradients (or color gradient measurements) in sensor measurements and determine if received color changes and/or color gradients are noticeable and/or outside an established range. In embodiments, for example, computer-readable instructions executed by a processor or controller may analyze changes and/or gradients over time in red, green and/or blue color light measurements for a specified time and determine if such measurements are identifiable and/or outside an established range. Similarly, in embodiments, for example, computer-readable instructions executed by a processor or controller may analyze changes and/or gradients over time in cyan, magenta, yellow and/or black color light measurements.

In embodiments, in response to received color sensor and/or detector measurements exceeding a threshold and/or sensor measurements being outside an established range, computer-readable instructions executable by a processor and/or controller may create and/or generate 250 a color value indicator and/or color value for received sensor measurements. In embodiments, for example, a color value indicator, value indicator, and/or color value may be representative of red color light values, blue color light values and/or green color values exceeding a threshold, and being in a brighter environment. In embodiments, a color value indicator, value indicator, and/or color value may be representative of only one color or may be representative of two, three or four colors. In embodiments, for example, such a color value indicator, value indicator, and/or color value may represent more light being present in an environment, room and/or building. In embodiments, a color value indicator, value indicator, and/or color value may be representative and/or indicative that cyan color light values, yellow color light values, magenta color light values, and/or black color light values being outside an established range, and also represent that the light and/or spectrum values may have gone from light to darker values. In embodiments, such a selection indicator and/or value may represent less light being present in an environment, room and/or building. In embodiments, computer-readable executable by a processor and/or controller may utilize a color value indicator, value indicator, and/or color value to retrieve, fetch and/or select media files from a database in a memory of a computing device.

In embodiments, one or more databases and/or a database module may be located in one or more memory module of a computing device. In embodiments, one or more databases or a database module may comprise a plurality of media files (e.g., analog or digital media files), where each of a plurality of media files may be assigned 260 and/or include one or more selection indicators, selection values and/or selection measurements representing classifications, conditions, and/or values under which that media file may be selected, retrieved and/or fetched from a database. In embodiments, media files may be music file, video files, image files and/or a combination of all of these types. In embodiments, the classifications, conditions and/or values may be associated with color changes and/or gradients which identify that more light is in an environment, that more red light is present in an environment, that less cyan light is in an environment or that a change in multiple light colors has occurred and/or is outside an established and/or identified range for a period of time. In embodiments, the classifications, conditions, and/or values of the selection indicators, selection values and/or selection measurements may be more based and/or associated with music and/or video genre, type, classification, tempo and/or mood, and corresponding and/or associated changes, gradients or measurements in color light. In embodiments, for example, such music, image, and/or video types, genre, tempo or the like may be fast, slow, uplifting, somber, jazz, pulsating, driving, rap, rhythm and blue, EDM and associated changes in color light associated with such music, image and/or video identifiers (types, genre, tempo, classification and/or mood). In embodiments, each media file may have one or more selection indicators, selection measurements and/or selection values representing classifications, conditions and/or values. For example, a music media file may have a selection indicator or selection measurement may represent uplifting music which may be associated with or correspond to identifying a large green color light measurement. In embodiments, a video media file may have a selection indicator or selection measurement may represent a somber mood and/or driving beat, which may be associated with a change in cyan and/or yellow color light measurements are outside an established range.

In embodiments, computer-readable instructions executed by a processor and/or controller may match 265 a generated and/or calculated color value indicator and/or color value with selection indicators and/or selection values of media files and may retrieve one or more media files from a database. In embodiments, all media files with selection indicators matching a generated and/or calculated value indicator or color value may be retrieved. In embodiments, one or more media files with selection indicators or selection measurements matching and/or being similar to calculated color value indicators may be retrieved according to prior criteria (e.g., number of media files able to be retrieved may be limited due to memory considerations; bandwidth considerations, weighting considerations, buffer considerations, threshold considerations, and/or media files having multiple matches and/or a large enough indicator or value).

In embodiments, computer-readable instructions executed by a processor and/or controller may communicate 270 (e.g., transfer and/or transmit) selected media files to a reproduction device. In embodiments, if media files are music files, a processor and/or controller may communicate selected music files to an audio receiver for playback on a speaker (or a sound reproduction system for audible playback). In embodiments, if media files are video and/or image files, a processor and/or controller may communicate video files and/or image files to a monitor and/or display, which may or may not have a speaker for reproducing audio (or a visual reproduction system for visual and/or audible playback).

For example, in embodiments, somber and/or slow music files (e.g., songs) may have selection indicators and/or values corresponding to and associated with darker colors (or changes to darker light or an increase in darker color light). In embodiments, for example, Lighter, more upbeat and more inspirational songs may have selection indicators or values corresponding to and/or associated with brighter colors (or an increase in color light in lighter colors such as green, blue, yellow, etc.). In embodiments, music file (e.g., songs about rain and/or stormy weather may have selection indicators and/or values that smaller measurements of color and/or changing an increase in darker color light representations of color (e.g., small values of green light, red light and/or blue light and/or an increase in red color, an increase in magenta or block color). Techno music file (e.g., songs) or club music files (e.g., EDM) files may have selection indicators or values that correspond to rapid changes in color over set periods of time (e.g., such as when red, green or blue lights are pulsating on and off which could be associated with and/or correspond to a night club environment. Similarly, uplifting video files may have selection indicators and/or selection measurements corresponding to an increase in lighter colors (e.g., increase in green light, yellow light) and somber or instructional or crime-based video files may have selection indicators and/or measurements corresponding to an increase in darker colors (e.g., increase in red light and/or magenta light).

In embodiments, a computing device may be a standalone device positioned in an outdoor environment. In embodiments, a computing device with color detection and/or analyzing software (e.g., computer-readable instructions stored in one or more memory modules and executed by one or more processors) may be housed in an intelligent umbrella, intelligent shading system, and/or intelligent charging system along with a color detector and/or color sensor. In embodiments, a computing device may be a mobile communications and/or computing device (e.g., smartphone, tablet, cellular phone) with a color detector and/or color sensor. In embodiments, a computing device may comprise artificial intelligence software and/or an artificial intelligence application programming interface (API), and a color sensor and/or color detector.

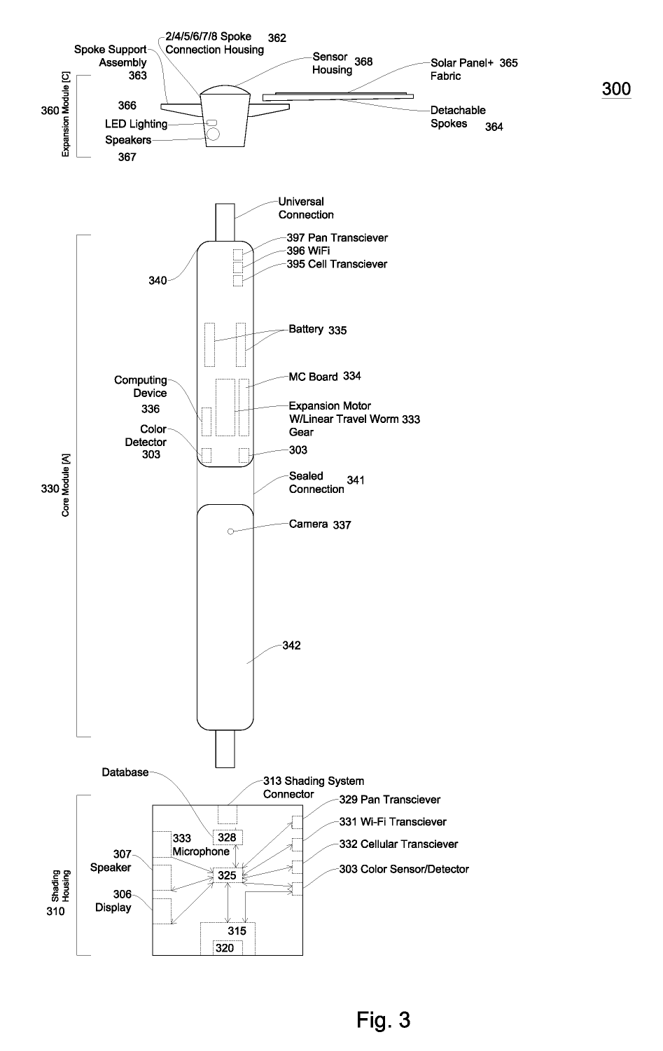

FIG. 3 illustrates a modular umbrella shading system including a color sensor or detector according to embodiments. In embodiments, a modular umbrella system 300 comprises a shading housing 310, a core assembly module housing (or core umbrella assembly) 330, and an expansion sensor assembly or module (or an arm extension assembly or module) 360. In embodiments, a first extension module or assembly may be positioned between a shading housing 310 and/or a core assembly module housing 330. In embodiments, a second extension module or assembly may be positioned between a core assembly module housing 330 and an expansion sensor assembly or module 330. In embodiments, a shading housing 310 may also be referred to as a base assembly and/or a base module. A modular umbrella system is described in detail in application Ser. No. 15/436,749, filed Feb. 17, 2017, entitled “Marine Vessel with Intelligent Shading System;” application Ser. No. 15/418,380, filed Jan. 27, 2017, entitled “Shading System with Artificial Intelligence Application Programming Interface;”, and application Ser. No. 15/394,080, filed Dec. 29, 2016, entitled “Modular Umbrella Shading System,” the disclosures of which are hereby incorporated by reference.

In embodiments, a universal umbrella connector or connection assembly may refer to a connection pair and/or connection assembly that may be uniform for all modules, components and/or assemblies of a modular umbrella system 300. In embodiments, having a universal umbrella connector or connection assembly may allow interchangeability and/or backward compatibility of the various assemblies and/or modules of the modular umbrella system 300. In embodiments, for example, a diameter of all or most of universal connectors utilized in a modular umbrella system may be the same. In embodiments, a universal connector or connection assembly may be a twist-on connector. In embodiments, a universal connector may be a drop in connector and/or a locking connector, having a male and female connector. In embodiments, a universal connector or connection assembly may be a plug with another connector being a receptacle. In embodiments, universal connector may be an interlocking plug receptacle combination. For example, universal connector may be a plug and receptacle, jack and plug, flanges for connection, threaded plugs and threaded receptacles, snap fit connectors, adhesive or friction connectors. In embodiments, for example, universal connector or connection assembly may be external connectors engaged with threaded internal connections, snap-fit connectors, push fit couplers. In embodiments, by having a universal connector or connection assembly for joints or connections between a base module or assembly 310 and a first extension module or assembly, a first extension module or assembly and a core assembly module or assembly 330, a core assembly module or assembly 330 and a second extension module or assembly, and/or a second extension module or assembly and an expansion sensor module or assembly 360, an umbrella or shading object manufacturer may not need to provide additional parts for additional connectors for attaching, coupling or connecting different modules or assemblies of a modular umbrella shading system. In addition, modules and/or assemblies may be upgraded easily because one module and/or assembly may be switched out of a modular umbrella system without having to purchase or procure additional modules because of the interoperability and/or interchangeability.

In embodiments, a core umbrella assembly or module 330 may be positioned between a first extension assembly or module and a second extension assembly or module. In embodiments, core umbrella assembly or module 130 may be positioned between a shading housing 310 and/or an expansion and sensor module or assembly 360. In embodiments, a core umbrella assembly or module 330 may comprise an upper core assembly 340, a core assembly connector or mid-section 341 and/or a lower core assembly 342. In embodiments, a core assembly connector 341 may be a sealer or sealed connection to protect a modular umbrella system from environmental conditions. In embodiments, a core umbrella assembly or module 330 may comprise two or more motors or motor assemblies. Although the specification may refer to a motor, a motor may be a motor assembly with a motor controller, a motor, a stator, a rotor and/or a drive/output shaft. In embodiments, a core umbrella assembly 330 may comprise an azimuth rotation motor 331, an elevation motor 332, and/or a spoke expansion/retraction motor 333. In embodiments, an azimuth rotation motor 331 may cause a core umbrella assembly 330 to rotate clockwise or counterclockwise about a shading housing 310. In embodiments, an azimuth rotation motor 331 may cause a core umbrella assembly 330 to rotate about an azimuth axis. In embodiments, a core umbrella assembly or module 330 may rotate up to 360 degrees with respect to a shading housing and/or base assembly or module 310.

In embodiments, an elevation motor 332 may cause an upper core assembly 340 to rotate with respect to a lower core assembly 342. In embodiments, an elevation motor 330 may rotate an upper core assembly 340 between 0 to 90 degrees with respect to the lower core assembly 342. In embodiments, an elevation motor 330 may rotate an upper module or assembly 340 between 0 to 30 degrees with respect to a lower assembly or module 342. In embodiments, an original position may be where an upper core assembly 340 is positioned in line and above the lower core assembly 342, as is illustrated in FIG. 3.

In embodiments, a spoke expansion motor 333 may be connected to an expansion and sensor assembly module 360 via a second extension assembly or module and cause spoke or arm support assemblies in a spoke expansion sensor assembly module 360 to deploy or retract outward and/or upward from an expansion sensor assembly module 360. In embodiments, an expansion extension assembly module 360 may comprise a rack gear and spoke connector assemblies (or arms). In embodiments, a spoke expansion motor 333 may be coupled and/or connected to a hollow tube via a gearing assembly, and may cause a hollow tube to move up or down (e.g., in a vertical direction). In embodiments, a hollow tube may be connected and/or coupled to a rack gear, which may be connected and/or coupled to spoke connector assemblies. In embodiments, movement of a hollow tube in a vertical direction may cause spoke assemblies and/or arms to be deployed and/or retracted. In embodiments, spoke connector assemblies and/or arms may have a corresponding and/or associated gear at a vertical rack gear.

In embodiments, a core assembly or module 330 may comprise motor control circuitry 334 (e.g., a motion control board 1334) that controls operation of an azimuth motor 331, an elevation motor 332 and/or an expansion motor 333, along with other components and/or assemblies. In embodiments, the core assembly module 330 may comprise one or more batteries 335 (e.g., rechargeable batteries) for providing power to electrical and mechanical components in the modular umbrella system 300. For example, one or more batteries 335 may provide power to motion control circuitry 334, an azimuth motor 331, an expansion motor 333, an elevation motor 332, a camera 337, a proximity sensor 338, a near field communication (NFC) sensor 338. In embodiments, one or more batteries 335 may provide power to an integrated computing device 336, although in other embodiments, an integrated computing device 36 may also comprise its own battery (e.g., rechargeable battery).

In embodiments, the core assembly 330 may comprise a separate and/or integrated computing device 336. In embodiments, a separate computing device 336 may comprise a Raspberry Pi computing device, other single-board computers and/or single-board computing device. Because a modular umbrella shading system has a limited amount of space, a single-board computing device is a solution that allows for increased functionality without taking up too much space in an interior of a modular umbrella shading system. In embodiments, a separate computing device 336 may handle video, audio and/or image editing, processing, and/or storage for a modular umbrella shading system 300 (which are more data intensive functions and thus require more processing bandwidth and/or power). In embodiments, an upper core assembly 340 may comprise one or more rechargeable batteries 335, a motion control board (or motion control circuitry) 334, a spoke expansion motor 333 and/or a separate and/or integrated computing device 336.

In embodiments, a core assembly connector/cover 341 may cover and/or secure a connector between an upper core assembly 340 and a lower core assembly 342. In embodiments, a core assembly connector and/or cover 341 may provide protection from water and/or other environmental conditions. In other words, a core assembly connector and/or cover 341 may make a core assembly 330 waterproof and/or water resistant and in other environments, may protect an interior of a core assembly from sunlight, cold or hot temperatures, humidity and/or smoke. In embodiments, a core assembly connector/cover 341 may be comprised of a rubber material, although a plastic and/or fiberglass material may be utilized. In embodiments, a core assembly connector/cover 341 may be comprised of a flexible material, silicone, and/or a membrane In embodiments, a core assembly connector/cover 341 may be circular and/or oval in shape and may have an opening in a middle to allow assemblies and/or components to pass freely through an interior of a core assembly connector or cover 341. In embodiments, a core assembly connector/cover 341 may adhere to an outside surface of an upper core assembly 340 and a lower core assembly 342. In embodiments, a core assembly connector/cover 341 may be connected, coupled, fastened and/or have a grip or to an outside surface of the upper core assembly 340 and the lower core assembly 342. In embodiments, a core assembly connector and/or cover 341 may be connected, coupled, adhered and/or fastened to a surface (e.g., top or bottom surface) of an upper core assembly and/or lower core assembly 342. In embodiments, a core assembly connector/cover 341 may cover a hinging assembly and/or reparation point, springs, and wires that are present between an upper core assembly 340 and/or a lower core assembly 342.

In embodiments, a core assembly or module 330 may comprise one or more cameras 337. In embodiments, one or more cameras 337 may be capture images, videos and/or sound of an area and/or environment surrounding a modular umbrella system 300. In embodiments, a lower core assembly 342 may comprise one or more cameras 337. In embodiments, a camera 337 may only capture sound if a user selects a sound capture mode on a modular umbrella system 300 (e.g., via a button and/or switch) or via a software application controlling operation of a modular umbrella system (e.g., a microphone or recording icon is selected in a modular umbrella system software application).

In embodiments, a core assembly 330 may comprise a power button to manually turn on or off power to components of a modular umbrella system. In embodiments, a core assembly or module 330 may comprise one or more proximity sensors 338. In embodiments, one or more proximity sensors 338 may detect whether or not an individual and/or subject may be within a known distance from a modular umbrella system 300. In embodiments, in response to a detection of proximity of an individual and/or subject, a proximity sensor 338 may communicate a signal, instruction, message and/or command to motion control circuitry (e.g., a motion control PCB 334) and/or a computing device 336 to activate and/or deactivate assemblies and components of a modular umbrella system 300. In embodiments, a lower core assembly 342 may comprise a proximity sensor 338 and a power button. For example, a proximity sensor 338 may detect whether an object is within proximity of a modular umbrella system and may communicate a message to a motion control PCB 334 to instruct an azimuth motor 331 to stop rotating a base assembly or module.

In embodiments, a core assembly or module 330 may comprise a near-field communication (NFC) sensor 339. In embodiments, a NFC sensor 339 may be utilized to identify authorized users of a modular umbrella shading system 300. In embodiments, for example, a user may have a mobile computing device with a NFC sensor which may communicate, pair and/or authenticate in combination with a modular umbrella system NFC sensor 339 to provide user identification information. In embodiments, a NFC sensor 339 may communicate and/or transmit a signal, message, command and/or instruction based on a user's identification information to computer-readable instructions resident within a computing device and/or other memory of a modular umbrella system to verify a user is authenticated and/or authorized to utilize a modular umbrella system 300.

In embodiments, a core assembly or module 330 may comprise a cooling system and/or heat dissipation system 343. In embodiments, a cooling system 343 may be one or more channels in an interior of a core assembly or module 330 that direct air flow from outside a modular umbrella system across components, motors, circuits and/or assembles inside a core assembly 330. For example, one or more channels and/or fins may be coupled and/or attached to components, motors and/or circuits, and air may flow through channels to fins and/or components, motors and/or circuits. In embodiments, a cooling system 343 may lower operating temperatures of components, motors, circuits and/or assemblies of a modular umbrella system 300. In embodiments, a cooling system 343 may also comprise one or more plates and/or fins attached to circuits, components and/or assemblies and also attached to channels to lower internal operating temperatures. In embodiments, a cooling system 343 may also move hot air from electrical and/or mechanical assemblies to outside a core assembly. In embodiments, a cooling system 343 may be fins attached to or vents in a body of a core assembly 330. In embodiments, fins and/or vents of a cooling system 343 may dissipate heat from electrical and mechanical components and/or assemblies of the core module or assembly 330.

In embodiments, a separate, detachable and/or connectable skin may be attached, coupled, adhered and/or connected to a core module assembly 330. In embodiments, a detachable and/or connectable skin may provide additional protection for a core assembly module against water, smoke, wind and/or other environmental conditions and/or factors. In embodiments, a skin may adhere to an outer surface of a core assembly.330. In embodiments, a skin may have a connector on an inside surface of the skin and core assembly 330 may have a mating receptacle on an outside surface. In embodiments, a skin may magnetically couple to a core assembly 330. In embodiments, a skin may be detachable and removable from a core assembly so that a skin may be changed for different environmental conditions and/or factors. In embodiments, a skin may connect to an entire core assembly. In embodiments, a skin may connect to portions of an upper core assembly 340 and/or a lower core assembly 342. In embodiments, a skin may not connect to a middle portion of a core assembly 330 (or a core assembly cover connector 341). In embodiments, a skin may be made of a flexible material to allow for bending of a modular umbrella system 300. In embodiments, a base assembly or shading housing 310, a first extension assembly, a core module assembly 330, a second extension assembly and/or an arm extension and sensor assembly 360 may also comprise one or more skin assemblies. In embodiments, a skin assembly may provide a cover for a majority of all of a surface area one or more of the base assembly or shading housing 310, first extension assembly, core module assembly 330, second extension assembly and/or arm extension sensor assembly 360. In embodiments, a core assembly module 330 may further comprise channels on an outside surface. In embodiments, a skin assembly may comprise two pieces. In embodiments, a skin assembly may comprise edges and/or ledges. In embodiments, edges and/or ledges of a skin assembly may be slid into channels of a core assembly module 330. In embodiments, a base assembly or shading housing 310, a first extension assembly, a second extension assembly 340 and/or an arm expansion sensor assembly 360 may also comprise an outer skin assembly. In embodiments, skin assemblies for these assemblies may be uniform to present a common industrial design. In embodiments, skin assemblies may be different if such as a configuration is desired by a user. In embodiments, skin assemblies may be comprise of a plastic, a hard plastic, fiberglass, aluminum, other light metals (including aluminum), and/or composite materials including metals, plastic, wood. In embodiments, a core assembly module 330, a first extension assembly, a second extension assembly, an arm expansion sensor assembly 360, and/or a base assembly or shading housing 310 may be comprised of aluminum, light metals, plastic, hard plastics, foam materials, and/or composite materials including metals, plastic, wood. In embodiments, a skin assembly may be provide protection from environmental conditions (such as sun, rain, and/or wind).

In embodiments, a second extension assembly connects and/or couples a core assembly module 330 to an expansion assembly sensor module (and/or arm extension assembly module) 360. In embodiments, an expansion sensor assembly module 360 may have universal connectors and/or receptacles on both ends to connect or couple to universal receptacles and/or connectors, on the core assembly 330 and/or expansion sensor assembly module 360. FIG. 3 illustrates that a second extension assembly or module may have three lengths. In embodiments, a second extension assembly may have one of a plurality of lengths depending on how much clearance a user and/or owner may like to have between a core assembly module 330 and spokes of an expansion sensor assembly or module 360. In embodiments, a second extension assembly or module may comprise a hollow tube and/or channels for wires and/or other components that pass through the second extension assembly or module. In embodiments, a hollow tube 349 may be coupled, connected and/or fixed to a nut that is connected to, for example, a threaded rod (which is part of an expansion motor assembly). In embodiments, a hollow tube 349 may be moved up and down based on movement of the threaded rod. In embodiments, a hollow tube in a second extension assembly may be replaced by a shaft and/or rod assembly.

In embodiments, an expansion and sensor module 360 may be connected and/or coupled to a second extension assembly or module. In embodiments, an expansion and sensor assembly or module 360 may be connected and/or coupled to a second extension assembly or module via a universal connector. In embodiments, an expansion and sensor assembly or module 360 may comprise an arm or spoke expansion sensor assembly 362 and a sensor assembly housing 368. In embodiments, an expansion and sensor assembly or module 360 may be connected to a hollow tube 349 and thus coupled to a threaded rod. In embodiments, when a hollow tube moves up and down, an arm or spoke expansion assembly 362 opens and/or retracts, which causes spokes/blades 364 of an arm extension assembly 363. In embodiments, arms, spokes and/or blades 364 may detachably connected to the arm or spoke support assemblies 363.

In embodiments, an expansion and sensor assembly module 360 may have a plurality of arms, spokes or blades 364 (which may be detachable or removable). Because the umbrella system is modular and/or adjustable to meet needs of user and/or environment, an arm or spoke expansion assembly 362 may not have a set number of arm, blade or spoke support assemblies 363. In embodiments, a user and/or owner may determine and/or configure a modular umbrella system 100 with a number or arms, spokes, or blades extensions 363 (and thus detachable spokes, arms and/or blades 364) necessary for a certain function and attach, couple and/or connect an expansion sensor assembly or module 360 with a spoke expansion assembly 362 with a desired number of blades, arms or spoke connections to a second extension module or assembly and/or a core module assembly or housing 330. Prior umbrellas or shading systems utilize a set or established number of ribs and were not adjustable or configurable. In contrast, a modular umbrella system 300 described herein has an ability to have a detachable and adjustable expansion sensor module 362 comprising an adjustable number of arm/spoke/blade support assemblies or connections 363 (and therefore a flexible and adjustable number of arms/spokes/blades 364), which provides a user with multiple options in providing shade and/or protection. In embodiments, expansion and sensor expansion module 360 may be detachable or removable from a second extension module and/or a core assembly module 330 and also one or more spokes, arms and/or assemblies 364 may be detachable or removable from arm or spoke support assemblies 363. Therefore, depending on the application or use, a user, operator and/or owner may detachably remove an expansion and sensor module or assembly 360 having a first number of arm/blade/spoke support assemblies 363 and replace it with a different expansion sensor module or assembly 360 having a different number of arm/blade/spoke support assemblies 363.

In embodiments, arms, blades and/or spokes 364 may be detachably connected and/or removable from one or more arm support assemblies 363. In embodiments, arms, blades, and/or spokes 364 may be snapped, adhered, coupled and/or connected to associated arm support assemblies 363. In embodiments, arms, blades and/or spokes 364 may be detached, attached and/or removed before deployment of the arm extension assemblies 363.

In embodiments, a shading fabric 365 may be connected, attached and/or adhered to one or more arm extension assemblies 363 and provide shade for an area surrounding, below and/or adjacent to a modular umbrella system 100. In embodiments, a shading fabric (or multiple shading fabrics) may be connected, attached, and/or adhered to one or more spokes, arms and/or blades 364. In embodiments, a shading fabric or covering 365 may have integrated therein, one or more solar panels and/or cells (not shown). In embodiments, solar panels and/or cells may generate electricity and convert the energy from a solar power source to electricity. In embodiments, solar panels may be coupled to a shading power charging system (not shown). In embodiments, one or more solar panels and/or cells may be positioned on top of a shading fabric 365. In embodiments, one or more solar panels and/or cells may be connected, adhered, positioned, attached on and/or placed on a shading fabric 365.

In embodiments, an expansion sensor assembly or module 360 may comprise one or more audio speakers 367. In embodiments, an expansion sensor assembly or module 360 may further comprise an audio/video transceiver. In embodiments, a core assembly 330 may comprise and/or house an audio/video transceiver (e.g., a Bluetooth or other PAN transceiver, such as Bluetooth transceiver 397). In embodiments, an expansion sensor assembly or module 360 may comprise an audio/video transceiver (e.g., a Bluetooth and/or PAN transceiver) In embodiments, an audio/video transceiver in an expansion sensor assembly or module 360 may receive audio signals from an audio/video transceiver 397 in a core assembly 330, convert to an electrical audio signal and reproduce the sound on one or more audio speakers 367, which projects sound in an outward and/or downward fashion from a modular umbrella system 300. In embodiments, one or more audio speakers 367 may be positioned and/or integrated around a circumference of an expansion sensor assembly or module 360.

In embodiments, an expansion sensor assembly or module 360 may comprise one or more LED lighting assemblies 366. In embodiments, one or more LED lighting assemblies 366 may comprise bulbs and/or LED lights and/or a light driver and/or ballast. In embodiments, an expansion sensor assembly or module 360 may comprise one or more LED lighting assemblies positioned around an outer surface of the expansion sensor assembly or module 360. In embodiments, one or more LED lighting assemblies 366 may drive one or more lights. In embodiments, a light driver may receive a signal from a controller or a processor in a modular umbrella system 300 to activate/deactivate LED lights. The LED lights may project light into an area surrounding a modular umbrella system 300. In embodiments, one or more lighting assemblies 366 may be recessed into an expansion or sensor module or assembly 360.

In embodiments, an arm expansion sensor housing or module 360 may also comprise a sensor housing 368. In embodiments, a sensor housing 368 may comprise one or more environmental sensors, one or more telemetry sensors, and/or a sensor housing cover. In embodiments, one or more environmental sensors may comprise one or more air quality sensors, one or more UV radiation sensors, one or more digital barometer sensors, one or more temperature sensors, one or more humidity sensors, and/or one or more wind speed sensors. In embodiments, one or more telemetry sensors may comprise a GPS/GNSS sensor and/or one or more digital compass sensors. In embodiments, a sensor housing 368 may also comprise one or more accelerometers and/or one or more gyroscopes. In embodiments, a sensor housing 368 may comprise sensor printed circuit boards and/or a sensor cover (which may or may not be transparent). In embodiments, a sensor printed circuit board may communicate with one or more environmental sensors and/or one or more telemetry sensors (e.g., receive measurements and/or raw data), process the measurements and/or raw data and communicate sensor measurements and/or data to a motion control printed circuit board (e.g., controller) and/or a computing device (e.g., controller and/or processor). In embodiments, a sensor housing 368 may be detachably connected to an arm connection housing/spoke connection housing to allow for different combinations of sensors to be utilized for different umbrellas. In embodiments, a sensor cover of a sensor housing 368 may be clear and/or transparent to allow for sensors to be protected from an environment around a modular umbrella system. In embodiments, a sensor cover may be moved and/or opened to allow for sensors (e.g., air quality sensors to obtain more accurate measurements and/or readings). In embodiments, a sensor printed circuit board may comprise environmental sensors, telemetry sensors, accelerometers, gyroscopes, processors, memory, and/or controllers in order to allow a sensor printed circuit board to receive measurements and/or readings from sensors, process received sensor measurements and/or readings, analyze sensor measurements and/or readings and/or communicate sensor measurements and/or readings to processors and/or controllers in a core assembly or module 330 of a modular umbrella system 300.

In embodiments, a base assembly or shading housing 310 and/or first extension assembly may be comprised of stainless steel. In embodiments, a base assembly or shading housing 310 and/or first extension assembly may be comprised of a plastic and/or a composite material, or a combination of materials listed above. In embodiments, a base assembly or shading housing 310 and/or first extension assembly may be comprised and/or constructed by a biodegradable material. In embodiments, a base assembly or shading housing 310 and/or first extension assembly may be tubular with a hollow inside except for shelves, ledges, and/or supporting assemblies. In embodiments, a base assembly or shading housing 310 and/or first extension assembly may have a coated inside surface. In embodiments, a base assembly or shading housing 310 and/or first extension assembly may have a circular circumference or a square circumference.

In embodiments, a base assembly or module or shading housing 310 may also a base motor controller PCB, a base motor, a drive assembly and/or wheels. In embodiments, a base assembly or shading housing may move to track movement of the sun, wind conditions, and/or an individual's commands. In embodiments, a shading object movement control PCB may send commands, instructions, and/or signals to a base assembly or shading housing 310 identifying desired movements of a base assembly or shading housing 310. In embodiments, a shading computing device system (including a SMARTSHADE and/or SHADECRAFT application) or a desktop computer application may transmit commands, instructions, and/or signals to a base assembly identifying desired movements of a base assembly. In embodiments, a base motor controller PCB may receive commands, instructions, and/or signals and may communicate commands and/or signals to a base motor. In embodiments, a base motor may receive commands and/or signals, which may result in rotation of a motor shaft. In embodiments, a motor shaft may be connected, coupled, or indirectly coupled (through gearing assemblies or other similar assemblies) to one or more drive assemblies. In embodiments, a drive assembly may be one or more axles, where one or more axles may be connected to wheels. In embodiments, for example, a base assembly or shading housing 310 may receive commands, instructions and/or signal to rotate in a counterclockwise direction approximately 15 degrees. In embodiments, for example, a motor output shaft would rotate one or more drive assemblies rotate a base assembly or shading housing 310 approximately 15 degrees. In embodiments, a base assembly or shading housing 310 may comprise more than one motor and/or more than one drive assembly. In this illustrative embodiment, each of motors may be controlled independently from one another and may result in a wider range or movements and more complex movements.

In embodiments, a shading housing 310 may comprise a shading system connector 313, one or more memory modules 315, one or more processors/controllers 325, one or more microphones 333, one or more transceivers (e.g., a PAN transceiver 329, a wireless local area network (e.g., WiFi) transceiver 331, and/or a cellular transceiver 332), one or more databases 328, one or more color sensors and/or detectors, and an artificial intelligence (AI“)” Application programming interface (“API”) 320. In embodiments, a base assembly may also include the same components and/or assemblies. In embodiments, one or more microphones 333 receives a spoken command and captures/converts the command into a digital and/or analog audio file. In embodiments, one or more processors/controllers 325 interacts and executes AI API 320 instructions (stored in one or more memory modules 315) and communicates and/or transfers audio files to a third party AI server (e.g., an external AI server or computing device). In embodiments, an AI API 320 may communicate and/or transfer audio files via and/or utilizing a PAN transceiver 329, a local area network (e.g., WiFi) transceiver 331, and/or a cellular transceiver 332. In embodiment, an AI API may receive communications, data, measurements, commands, instructions and/or files from an external AI server or computing device and perform and/or execute actions in responses to these communications.

In embodiments, a shading system and/or umbrella 300 may communicate via one or more transceivers. This provides a shading system with an ability to communicate with external computing devices, servers and/or mobile communications device in almost any situation. In embodiments, a shading system 300 with a plurality of transceivers (e.g., a PAN transceiver 329, a local area network (e.g., WiFi) transceiver 331, and/or a cellular transceiver 332) may communicate when one or more communication networks are down, experiencing technical difficulties, inoperable and/or not available. For example, a WiFi wireless router may be malfunctioning and a shading system 300 with a plurality of transceivers may be able to communicate with external devices via a PAN transceiver 329 and/or a cellular transceiver 332. In addition, an area may be experiencing heavy rains or weather conditions and cellular communications may be down and/or not available (and thus cellular transceivers 332 may be inoperable). In these situations, a shading system 300 with one or more transceivers may communicate with external computing devices via the operating transceivers. Since most shading systems 300 may not have any communication transceivers, the shading systems 300 described herein is an improvement over existing shading systems that have no communication capabilities and/or limited communication capabilities.

In embodiments, a shading housing and/or base assembly 310 may further comprise a color sensor and/or detector 303. In embodiments, a color sensor and/or detector 303 may detect and/or capture changes in a color spectrum (e.g., changes in a blue, red and/or green color light or changes in cyan, magenta, yellow and/or black color light). In embodiments, a color sensor and/or detector 303 may communicate sensor measurements (e.g., raw measurements and/or processed measurements) to a processor 325. In embodiments, computer-readable instructions stored in a memory 315 executed by a processor 325 may analyze received sensor measurements and determine if color light changes (and/or color gradients) meet and/or exceed any preset or established thresholds. In embodiments, if color light changes exceed a threshold and/or other conditions are met, a processor and/or controller may generate a color value indicator or a value indicator corresponding to and/or based at least in part on the color change and/or color sensor measurement. In embodiments, a processor or controller 325 may communicate one or more signals, instructions, commands and/or messages to database 328 to determine if selection indicators and/or selection measurements assigned to media files (stored in the database 328) match and/or are similar to value indicators and/or color values generated for the captured sensor measurements. In embodiments, a processor and/or controller along with computer-readable instructions executable by the processor and/or controller may retrieve media files that have selection indicators matching or having a similarity to value indicators and/or color values. In embodiments, selected media files may be transferred to an audio receiver and/or speaker for playback by a speaker 307 that is part of a shading housing 310 and/or base assembly of an intelligent shading system 300. In embodiments, selected media files may be transferred to a display 306 for visual playback of the media files. In embodiments, machine learning and/or artificial intelligence may assist in determining media files that are selected for retrieval and playback. In embodiments, a database may be located in a server and/or computing device external to an intelligent shading system 300 and media files may be selected and/or retrieved from an external database. In embodiments, an AI API 320 may be utilized in assisting and retrieving media files from an external database.

In embodiments utilizing an external database, a color sensor and/or detector 303 may detect and/or capture changes in a color spectrum (e.g., changes in a blue, red and/or green color light or changes in cyan, magenta, yellow and/or black color light). In embodiments, a color sensor and/or detector 303 may communicate sensor measurements (e.g., raw measurements and/or processed measurements) to a processor 325. In embodiments, computer-readable instructions stored in a memory 315 executed by a processor 325 may execute an artificial intelligence (AI) application programming interface (API) 320, which may communicate sensor measurements to an external AI server. In embodiments, an external AI server (or machine learning server) may analyze received sensor measurements and determine if color light changes meet and/or exceed any preset thresholds. In embodiments, computer-readable instructions executed by a processor of an external AI server may generated indicator values or color values for captured color sensor measurement changes. In embodiments, an external AI server may communicate with a database to retrieve media files stored therein having selection indicators and/or selection values associated with, affiliated with and/or corresponding to color indicator values for the captured sensor measurements. In embodiments, an external AI server may communicate and/or transfer selected media files to an intelligent shading system 300. In embodiments, an external AI server may transfer or communicate media files via a transceiver 389, 391 or 392 to processors 325 (and/or memory 321) and further to a speaker 307 and/or display for audible and/or visual playback. In embodiments, this allows an intelligent shading system 300 to offload processing power. In other words, artificial intelligence and/or machine learning software may not need to be stored on an intelligent shading system 300 and/or third party artificial intelligence and/or machine learning software hosted on remote servers may be utilized to perform this processing or these actions.

In embodiments, an audio receiver or transceiver may be located in a sensor housing 310 and may communicate with a speaker 307 via wired connections or personal area network communications (e.g., Bluetooth, Zigbee). In embodiments, an audio receiver or transceiver may be located in a core module assembly and/or an expansion sensor module 360. In these embodiments, for example, media files (e.g., digital music files) may be communicated from a transceiver (e.g., 329, 331, 332) in a shading housing 310 to a transceiver 395 396 397 in a core module 330 and played on a speaker in a core module 330. Similarly, for example, digital media files (e.g., digital music files) may be communicated from a transceiver (e.g., 329, 331, 332) in a shading housing 310 to a transceiver in an expansion module and played on one or more speakers 367 in an expansion module 360.

In embodiments, a core module assembly 330 may comprise one or more color sensors and/or detectors 303. In embodiments, one or more color detectors 303 may face and thus capture light from different directions in an environment where an intelligent shading system 300 is installed (which allows for verification that spectrum light has changed from a number of different directions and that a single light source (e.g., a laser or another colored light source) may be tricking or spoofing a color detector 303. In embodiments, color sensors and/or detectors 303 may detect and/or capture changes in a color light in a spectrum (e.g., changes in a blue, red and/or green color light or changes in cyan, magenta, yellow and/or black color light). In embodiments, one or more color sensors and/or detectors 303 may communicate sensor measurements (e.g., raw measurements and/or processed measurements) to a processor in an integrated computing device 336 (e.g. such as a Raspberry PI single board computer). In embodiments, computer-readable instructions stored in a memory of an integrated computing device 336 and executed by a processor of an integrated computing device may analyze received sensor measurements and determine if color light changes meet and/or exceed any preset thresholds. In embodiments, if color spectrum changes exceed a threshold, computer-readable instruction executed by a processor may generate or calculate one or more color light values, value indicators, and/or color value indicators. In embodiments, a processor may communicate one or more signals, instructions, commands and/or messages to a database in an integrated computing device to determine if generated color value indicators match and/or similar to selection indicators and/or selection measurements assigned to media files in the database and retrieve media files meeting criteria associated and/or based on a color light change (e.g., value indicators and/or color value indicators for sensor measurements match and/or similar to selection indicators assigned to media files). In embodiments, selected media files (e.g., audio or music files) may be transferred to an audio receiver and/or speaker for playback by a speaker (e.g., speaker 367 (that is part of a core module 330 and/or an expansion sensor module 360). In embodiments, selected digital audio files may be communicated via a PAN transceiver 397 or a WiFi transceiver 396 to a speaker 367 in a sensor expansion module 360 (where the speaker 367 and/or audio received coupled thereto has a PAN and/or WiFi transceiver).

In embodiments, machine learning and/or artificial intelligence may assist in determining digital audio files that are selected for retrieval and playback. In embodiments, a database housing digital media files may be located in an external server and/or computing device physically separate from an intelligent shading system and such digital media files may be selected and/or retrieved from such external database. In embodiments, an AI API may be located in a memory module of an integrated computing device 336 and may be utilized in assisting and retrieving digital media files from an external database. . In embodiments, computer-readable instructions stored in a memory executed by a processor in an integrated computing device 336 of an intelligent shading system 300 may execute an artificial intelligence (AI) application programming interface (API), which may communicate sensor measurements to an external AI server. In embodiments, an external AI server (or machine learning server) may analyze received sensor measurements and determine if color spectrum changes meet and/or exceed any preset thresholds. In embodiments, an external AI server may communicate with a database to retrieve digital media files associated with, affiliated with and/or based on color spectrum changes and/or selected indicators. In embodiments, an external AI server may communicate and/or transfer selected digital media files to an integrated computing device 336 in an intelligent umbrella shading system 300. In embodiments, an external AI server may transfer or communicate digital media files via a transceiver 397 396 395 to one or more processors (and/or memory) of an integrated computing device and further to a speaker (e.g., speaker 367 or speaker 307) for playback.

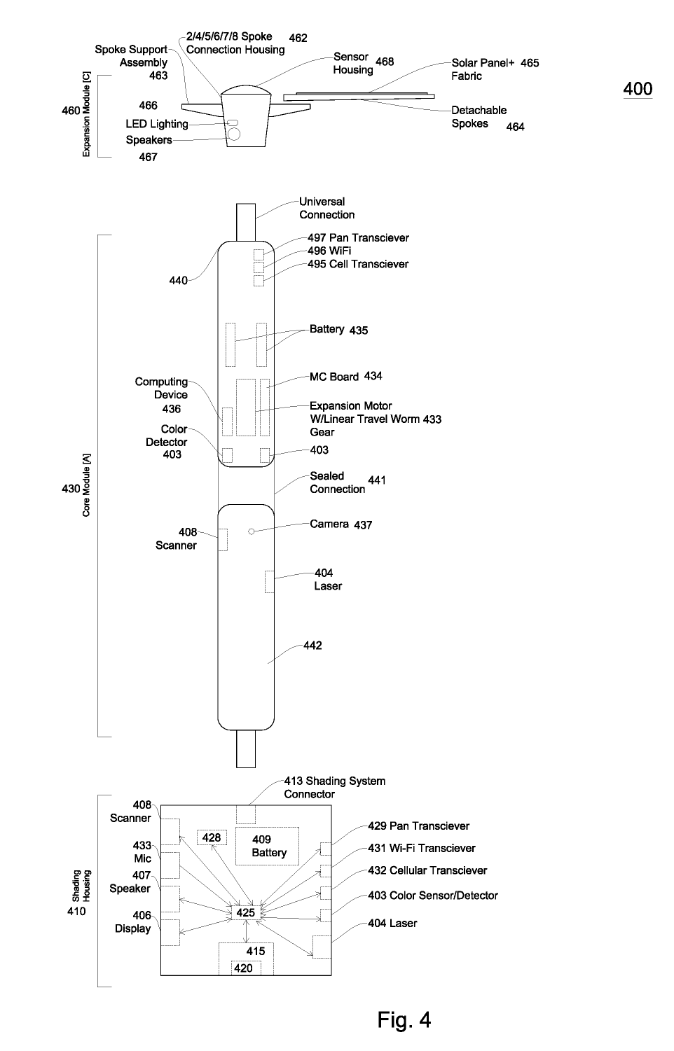

FIG. 4 illustrates an intelligent shading system comprising one or more laser devices and/or one or more two dimensional scanners according to embodiments. In embodiments, an intelligent shading system 400 may comprise one or more color detectors 403, which operate in accordance with the description immediately above with respect to FIG. 3. In embodiments, an intelligent shading system 400 may comprise a shading housing 410, a core module assembly 430 and/or an expansion sensor module assembly 460. In embodiments, a core module assembly 430 may comprise one or more laser devices 404, where the one or more laser devices 404 further may be utilized for proximity detection. In FIG. 4, only one laser device 404 may be illustrated, but a core assembly module 430 may comprise one or more laser devices 404 which may be positioned about an intelligent shading system 400 to provide up to approximately 360 degree coverage on an area surrounding and/or adjacent to an intelligent shading system 400 to determine if objects and/or individuals are present.

In embodiments, a shading housing 410 may further comprise a power source (e.g., battery 409). In embodiments, a battery 409 may provide power for components in a shading housing (e.g., display 406, microphone 433, speaker 407, scanner 408, processor 425, transceivers 429, 431, 432, color sensor or detector 403, and/or laser device 404.

In embodiments, one or more laser devices 404 may comprise a laser light source (e.g., a laser diode or a light emitting diode), supporting electronics or components, and/or a sensor (e.g., a photoelectric sensor such as a photodiode or phototransistor receiver). In embodiments, a laser light source emits and/or transmits a light beam and a light beam reflection or a diffused light beam reflection is received at a sensor. If an object is present within a field of a light source, an object acts as a reflector and a detection of light is based off of light reflected and/or diffused from a disturbance object. In embodiments, a light source may communicate and/or transmit a beam of light (e.g., a pulsed infrared, a visible red and/or a laser beam) and a beam of light may diffuse in a number of directions. In embodiments, diffusion of light in a number of directions may fill a detection area. In embodiments, an object and/or individual may enter a detection are and an object and/or individual may deflect a portion back to a light sensor or detector (or laser light sensor or detector). In embodiments, if object detection occurs, a laser device may transmit a signal, command, instruction and/or message to a processor or controller (e.g., a processor or controller) in an integrated computing device 336 of an intelligent shading system.

In embodiments, a controller and/or processor and/or computer-readable instructions executed by a processor of an integrated computing device 436 may communicate a signal, command, instruction and/or message to a speaker (e.g., speaker 467 or speaker 407). In embodiments, if an alarm is to be emitted, then an alarm may be reproduced by a speaker to alert an owner or operator of presence of an object and/or individual). In embodiments, if a laser proximity sensor 404 is utilized to turn on or activate an intelligent shading system 400, a processor and/or controller in a computing device 436 (and/or computer-readable instructions executed by a processor in a computing device) may communicate a signal, command, instruction and/or message to activate a power source (e.g., rechargeable battery 435 or 409) or cause a power source to provide power to components of an intelligent shading system and place these components and/or assemblies (sensors, motors, cameras, etc.) in an active state). In embodiments, for example a processor and/or controller in a computing device 436 (and/or computer-readable instructions executed by a processor in a computing device) may communicate a signal, command, instruction and/or message to one or more lighting assemblies to activate the one or more lighting assemblies to alert an operator and/or owner of presence of an object and/or individual. In embodiments, a processor and/or controller in a computing device 436 (and/or computer-readable instructions executed by a processor in a computing device) may communicate a command, signal, instruction and/or message to an external third party server via a transceiver (e.g., a PAN transceiver 497, a WiFi transceiver 496, and/or a cellular transceiver 495). In embodiments, a third party server may be a home/building security server and alert a home or building server of a potential intruder, or a smart home server to alert a smart home or smart building server that an object and/or individual has been sensed in a proximity of an intelligent shading system 400.

In embodiments, an intelligent shading system 400 may comprise or further comprise a two-dimensional (2D) scanner 408. In embodiments, a two-dimensional scanner 408 may be located and/or positioned on or within a core assembly module 430 of an intelligent shading system. In embodiments, a two-dimensional scanner 408 may be located on or within, for example, an expansion sensor module 460 and/or a shading housing 410 or base assembly. In embodiments, location may depend on an area that a 2D scanner may be expected to cover and/or monitor by capturing images and/or video and either analyzing such video or providing such video or images to other computing devices for analyzation. In embodiments, one or more two-dimensional scanners 408 may be located and/or positioned on core assembly module 430 to attempt to cover and/or scan as much area as selected by an intelligent shading system owner or operation. In embodiments, 2D scanners may capture images of larger areas because rather than capturing images one line at a time, a two-dimensional scanner 408 captures an entire horizontal and vertical area (e.g., 200 pixels by 200 pixels). In other words, a two-dimensional scanner 408 may capture an image of an area rather than scanning line-by-line (e.g., 2D image sensors capture entire area images rather than a single row of pixels)i. In embodiments, one or more two-dimensional scanners 408 may capture 2D images of an area and may communicate and/or transfer on or more 2D images to an integrated computing device 436 in an intelligent shading system 400. In embodiments, computer-readable instructions stored in a memory (e.g., of an integrated computing device 436) may be fetched and/or executed by a processor or controller (e.g., of an integrated computing device 436) and receive captured 2D images from a two-dimensional scanner. In embodiments, computer-readable instructions executed by a processor may compare received 2D images against or to stored 2D images (e.g., which may be stored in a database in an integrated computing device 436) to identify if objects, individuals or background present in captured 2D images matches and/or is similar to objects, individuals and/or background in stored 2D images. In embodiments, if a match or similarity is determined, computer-readable instructions executed by a processor or controller (e.g., of an integrated computing device) may communicate signals, messages, instructions and/or commands to assemblies, sensors and/or components of an intelligent shading system 400. In embodiments, for example, if a captured image matches a stored image of an authorized user of an intelligent shading system 400, computer-readable instructions executed by a processor and/or controller may generate a command, signal, instruction and/or message to a) communicate a greeting to an authorized user by communicating an audio file to an audio receiver and/or speaker in an intelligent shading system 400; and/or b) communicate and/or transmit preset or individualize settings to different components of an intelligent shading system 400 to initiate setup of the intelligent shading system for to authorized user (e.g., elevation setting for an elevation motor; azimuth setting for an elevation motor; activation of an audio system to play music for the authorized user). In addition, in embodiments, for example, if a captured image matches or is similar a stored image of an unauthorized, undesirable, or illegal user of an intelligent shading system 400, computer-readable instructions executed by a processor and/or controller may generate a command, signal, instruction and/or message to a) communicate an alert or warning message to an owner/operator by communicating an audio file to an audio receiver and/or speaker for playback ; or b) communicate a message via a transceiver to a third party server (e.g., home security and/or first responders) that an unauthorized or unwanted user is present near an intelligent shading system (e.g., a burglar or even an underage child for which the intelligent shading system presents a hazard or dangerous situation).

In embodiments, if a captured image matches or is similar to an image of a dangerous situation or other known situation (e.g., like an image of flames, smoke, snow, hail, and/or heavy rain), computer-readable instructions executed by a processor and/or controller may generate a command, signal, instruction and/or message to a) communicate an alert or warning message to an owner/operator that an emergency situation is occurring (either by communicating visual, textual and/or audible warnings); to b) communicate a message, instruction, command and/or signal to move components, assemblies or motors to move an intelligent shading system to an appropriate position (closed position if fire or smoke in a monitored area and/or open position if a heavy rain in a monitored area); or c) communicate a message, instruction, command and/or signal to external servers and/or computing devices. In embodiments, computer-readable instructions executed by a processor may analyze two-dimensional images (via image recognition) to identify objects or individuals in 2D images captured by a 2D scanner. In embodiments, computer-readable instructions executed by a processor may compare extracted objects or individuals to known images in order to determine appropriate actions (such as communicate alerts (audible, visual and textual) and/or move components, assemblies and/or systems of the intelligent shading systems 400) and communicate messages, instructions, signals and/or commands to perform and/or execute the appropriate actions.

In embodiments, an intelligent shading system 400 may not have enough processing power and/or bandwidth to handle image recognition and/or image matching and may need to utilize third party servers (such as artificial intelligence servers such as Amazon, Google, or others) to perform machine learning, artificial intelligence and/or image processing remotely. In embodiments, for example, 2D images captured by a 2D scanner 408 may be communicated by a processor or controller in an integrated computing device 436 (or other processor or controller) (via a transceiver 495 496 497) to a remote server for image analyzation and/or image processing. As discussed previously, an intelligent shading system 400 may communicate with remote servers via an AI (or machine learning) API. In embodiments, remote servers may either pattern match and/or analyze captured 2D images to determine if matches and/or similarities exist (e.g., with authorized or unauthorized users and with known and/or dangerous conditions). In embodiments, for example, if matches and/or similarities are found or determined, a remote server may communicate commands, signals, messages and/or instructions to an intelligent shading system 400 via a transceiver (e.g., 495 cellular transceiver; 496 WiFi transceiver; and/or 497 PAN transceiver) to cause an intelligent shading system to a) generate textual, audible and/or visible alarms; b) move components and/or assemblies to desired positions or conditions; or c) to cause certain components, assemblies and/or systems to activate and/or shut down (e.g., cameras, power supplies, sensors).

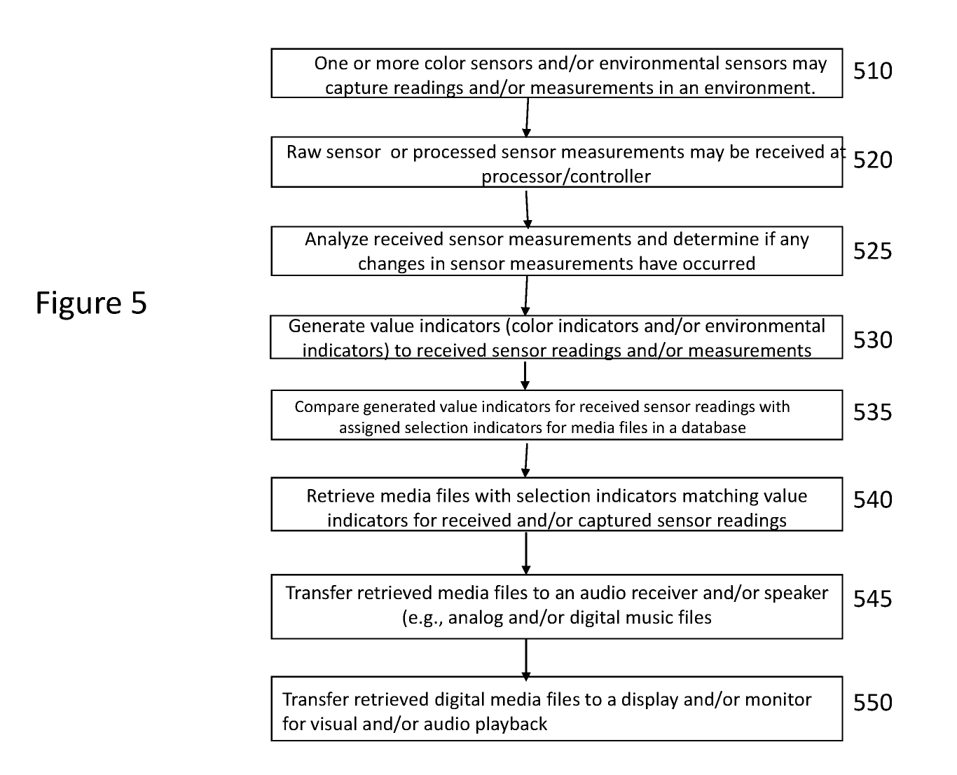

FIG. 5 illustrates a method and/or process for capturing measurements from a plurality of sensors and selecting digital media files in response. In embodiments, one or more sensors may capture 510 readings and/or measurements in an environment and may communicate captured sensor readings and/or measurements to a processor or controller. In embodiments, for example, one or more sensors may be a color or color gradient sensor, a wind sensor, a temperature sensor, a humidity sensor, an air quality sensor and/or an ultraviolet radiation sensor. This list of sensors are merely example representations and other sensors may be utilized in place of and/or in conjunction with the identified sensors. In embodiments, raw sensor readings or measurements and/or processed sensor readings or measurements may be received 520 at a processor or controller from one or more sensors. In embodiments, computer-readable instructions may be stored in a memory, fetched from a memory and/or may be executed by a controller and/or processor to analyze 525 the received sensor measurements and determine if any changes in sensor measurements have occurred or taken place (e.g., has wind speed increased or decreased, has a captured color spectrum gotten darker and/or lighter). In embodiments, computer-readable instructions executed by a processor may assign 530 color values, environmental values, value indicators, environmental value indicators, color value indicators) to received sensor readings and/or measurements based upon whether a change has occurred and/or whether in change in sensor measurements meets and/or exceeds a predetermined threshold. In embodiments, one value indicator for captured sensor measurements may represent a change to a lighter color in a spectrum, a second value indicator may represent a change to a darker color in a spectrum, and/or a third value indicator may represent a rapid color change and/or gradient. Similarly, one value indicator for a temperature sensor may represent a higher temperature, a second value indicator for a temperature sensor may represent a lower temperature, a third value indicator may represent a rapid increase in temperature and/or a fourth value indicator may represent a rapid decrease in temperature. In embodiments, for example, one value indicator may represent a decrease in an air quality sensor value and a second value indicator may represent a rapid and/or troubling decrease in air quality sensor value.

In embodiments, a database may store a plurality of digital and/or analog media files, which may be selected by an operator of a computing device (whether standalone and/or incorporated and/or integrated in another electronic device (e.g., an intelligent shading system). In embodiments, the plurality of digital and/or analog media files may have selection indicators which may represent characteristics, types, assignments, tempo, mood (inspirational, teaching and/or somber) for each of the plurality of digital and/or analog media files. In embodiments, a digital and/or analog media file may have one or more selection indicators identifying what type of classification can be placed for each of media files. For example, a media file may be considered an upbeat and/or inspirational media file and may have selection indicators classifying the media file as upbeat and/or inspirational, which may be associated with light colors, color change to lighter environment, and easier environmental conditions (low humidity, good air quality readings, lower winds measurements). For example, a media file may be considered a dark, depressing or somber media file and/or may be classified as a rainy or stormy media file, which may be associated with darker colors and/or rough environmental conditions (higher winds, clouds, dropping temperature). For example, a media file may be considered a media file for sunny weather or bright light, and may have one or more selection indicators classifying the media file as such. For example, a media file may be classified as a media file associated with smog conditions and/or poor air quality and may have a selection indicator classifying the media as such. For example, a media file may be techno digital music file, may be classified as a media file associated with high wind conditions and decreasing light conditions may have corresponding selection indicators or selection measurements. For example, a media file may be a music file entitled “Be Happy” and a may be classified as a media file associated with changes to lighter colors, good air quality, a mid-range temperature and a mid-range humidity and may have corresponding selection indicators or selection measurements. For example, a media file may be a morning workout video file and may be classified as a media file associated with medium temperatures and increasing lighter colors and good air quality readings. For example, a media file may a digital music file entitled “Thunderstruck” by AC/DC, may be classified as a media file associated with heavy rain and heavy wind conditions may have corresponding selection indicators or selection measurements. In embodiments, classifications and/or associated selection indicators may be automatically assigned to digital and/or analog media files. In embodiments, classifications and/or associated selection may be identified or customized by users and/or operators of computing devices and/or digital music applications and/or store fronts.

In embodiments, computer-readable instructions executed by a processor may compare 535 assigned value indicators (e.g., environmental value indicators and/or color value indicators) for received and/or processed sensor readings with selection indicators for media files in a database. In embodiments, computer-readable instructions may retrieve 540 media files with selection indicators or selection indicators matching and/or similar to value indicators (e.g., environmental value indicators and/or color value indicators) for received and/or captured sensor readings and communicate retrieved media files to a processor and/or controller. In embodiments, a processor and/or controller may store (e.g., temporarily or permanently) retrieved media files in a memory of a computing device. In embodiments, computer-readable instructions executed by a processor may transfer 545 retrieved media files to an audio receiver and/or speaker (e.g., analog and/or digital music files). In embodiments, computer-readable instructions executed by a processor or controller may transfer 550 retrieved digital media files to a display and/or monitor for visual and/or audio playback (e.g., analog and/or digital video files).

FIGS. 2 and 5 are flow diagram of an embodiment of a process to generate a recommendation list of online content. Of course, embodiments are intended to be illustrative examples rather than be limiting with respect to claimed subject matter. Likewise, for ease of explanation, an embodiment may be simplified to illustrate aspects and/or features in a manner that is intended to not obscure claimed subject matter through excessive specificity and/or unnecessary details. Embodiments in accordance with claimed subject matter may include all of, less than, or more than blocks 210-270. Also, the order of blocks 510-550 is merely as an example order.

A computing device may be a server, a computer, a laptop computer, a mobile computing device, a mobile communications device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

Internal architecture of a computing device includes one or more processors (also referred to herein as CPUs), which interface with at least one computer bus. Also interfacing with computer bus are persistent storage medium/media, network interface, memory, e.g., random access memory (RAM), run-time transient memory, read only memory (ROM), etc., media disk drive interface, an interface for a drive that can read and/or write to media including removable media such as floppy, CD-ROM, DVD, etc., media, display interface as interface for a monitor or other display device, keyboard interface as interface for a keyboard, mouse, trackball and/or pointing device, and other interfaces not shown individually, such as parallel and serial port interfaces, a universal serial bus (USB) interface, and the like.

Memory, in a computing device and/or a modular umbrella shading system, interfaces with computer bus so as to provide information stored in memory to processor during execution of software programs such as an operating system, application programs, device drivers, and software modules that comprise program code or logic, and/or computer-executable process steps, incorporating functionality described herein, e.g., one or more of process flows described herein. CPU first loads computer-executable process steps or logic from storage, storage medium/media, removable media drive, and/or other storage device. CPU can then execute the stored process steps in order to execute the loaded computer-executable process steps. Stored data, e.g., data stored by a storage device, can be accessed by CPU during the execution of computer-executable process steps.

Non-volatile storage medium/media is a computer readable storage medium(s) that can be used to store software and data, e.g., an operating system and one or more application programs, in a computing device or storage subsystem of an intelligent shading object. Persistent storage medium/media also be used to store device drivers, such as one or more of a digital camera driver, monitor driver, printer driver, scanner driver, or other device drivers, web pages, content files, metadata, playlists and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in an intelligent shading controller may include or may execute a variety of possible applications, such as a software applications enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A computing device or a processor or controller in an intelligent shading object may also include or execute an application to communicate content, such as, for example, textual content, multimedia content, or the like. A computing device or a processor or controller in an intelligent shading object may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in an intelligent shading object may also include imaging software applications for capturing, processing, modifying and transmitting image files utilizing the optical device (e.g., camera, scanner, optical reader) within a mobile computing device.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. For example, the server may be the server described in detail above. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. A computing device, comprising:
a color spectrum detector to detect a change in a color spectrum over a specified period of time and to generate a signal representative of color spectrum change;
a memory;
a processor;
a database, the database housing digital media files; and
computer-readable instructions, stored in the memory, fetched from the memory and executed by the processor to:
receive the signal representative of the color spectrum change;
generate a value indicator based at least in part on the received color spectrum change;
select one or more digital media files from the database, the selected one or more digital media files having a selection indicator corresponding to the value indicator representative of the color spectrum change; and
retrieve the selected one or more digital media files.

2. The computing device of claim 1, wherein the one or more digital media files are one or more digital music files.

3. The computing device of claim 2, further comprising a sound reproduction system, wherein the one or more retrieved digital music files are communicated to the sound reproduction system for audible playback.

4. The computing device of claim 1, wherein the one or more digital media files are one or more digital video files.

5. The computing device of claim 4, further comprising a visual reproduction system, wherein the one or more retrieved digital video files are communicated to the visual reproduction system for visual playback.

6. The computing device of claim 1, wherein the color spectrum detector detects at least one of a red color spectrum change, a blue color spectrum change, or a green color spectrum change.

7. The computing device of claim 1, wherein the color spectrum detector detects at least one of a cyan color spectrum change, a yellow color spectrum change, or a magenta color spectrum change.

8. A method of selecting of media files in response to a color change, comprising:
receiving, at a controller, a color change measurement from a color sensor;
generating a value indicator, the value indicator being based at least in part on the color change measurement;
accessing, from a memory, one or more media files having a selection indicator matching the value indicator for the color change measurement; and
communicating the one or more retrieved media files.

9. The method of claim 8, wherein the media files are music files.

10. The method of claim 9, further comprising a sound reproduction system, the music files being transferred to the sound reproduction system for audible playback of the music files.

11. The method of claim 8, wherein the media files are video files.

12. The method of claim 11, further comprising a visual reproduction system, the video files being transferred to the sound reproduction system for visual playback of the video files.

13. The method of claim 8, wherein the color sensor detects changes in at least one of a cyan color spectrum, a yellow color spectrum, or a magenta color spectrum.

14. The method of claim 8, wherein color sensor color detects changes in at least one of a red color spectrum, a blue color spectrum, or a green color spectrum.

15. A computing device, comprising:
a color detector to detect a change in one or more color spectrums over a specified period of time and to generate one or more color change measurements;
one or more environmental sensors, the one or more environmental sensors to detect changes in environmental conditions and to generate one or more environmental measurements;
one or more memory modules;
one or more processors;
a database, the database housing media files; and
computer-readable instructions, stored in the one or more memory modules, accessed from the one or more memory modules and executed by the one or more processors to:
obtain the one or more color measurements and generate one or more color value indicators based at least in part on the obtained one or more color measurements;
obtain the one or more environmental measurements and generate one or more environmental value indicators based at least in part on the obtained one or more environmental measurements; and
assign one or more selection indicators to the media files in database.

16. The computing device of claim 15, the computer-readable instructions executed by the one or more processors further to:
select and retrieve one or more media files from the database having selection indicators corresponding to the generated color value indicators representative of the color spectrum change.

17. The computing device of claim 15, the computer-readable instructions executed by the one or more processors further to:
select and retrieve one or more media files from the database having selection indicators corresponding to the generated one or more environmental indicators representative of the environmental measurements.

18. The computing device of claim 15, the computer-readable instructions executed by the one or more processors further to:
calculate a combined value indicator by performing a mathematical operation on the one or more environmental value indicators and the one or more color value indicators.

19. The computing device of claim 18, the computer-readable instructions executed by the one or more processors further to:
select and retrieve one or more media files from the database having selection indicators corresponding to the combined value indicator.

20. The computing device of claim 15, the computer-readable instructions further to:
select and retrieve one or more media files from the database having selection indicators corresponding to both the one or more environmental value indicators and the one or more color value indicators.
